(19) United States
(12) Patent Application Publication
(10) Pub. No.: US 2008/0026852 A1
(43) Pub. Date: Jan. 31, 2008

(54) Game system and game control method

(76) Inventor: Tomio Kikuchi, Tokyo (JP)

Correspondence Address: JORDAN AND HAMBURG LLP, 122 EAST 42ND STREET, SUITE 4000, NEW YORK, NY, 10168, US

(21) Appl. No.: 11/881,634

(22) Filed: Jul. 26, 2007

(30) Foreign Application Priority Data
Jul. 28, 2006 (JP) 2006-207254

(51) Int. Cl. A63F 13/12; A63F 13/00

(52) U.S. Cl. 463/42; 463/25

(57) ABSTRACT

On a top portion of a server, there are provided notice means of 1st notice portions consisting of rotary lights. The 1^{st} notice portions are turned on, when there is a terminal machine for which the lottery of the jackpot is executed. On a top portion of each terminal machine, there are provided 2nd notice portions consisting of rotary lights for notifying information concerning the jackpot. The 2^{nd} notice portion is turned on of the game machine which can join the lottery of the jackpot. Therefore, the game motivation caused by the jackpot is fully applied to the game system in which the jackpot may occur regardless of player's operation.

### BACKGROUND OF THE INVENTION

The present invention relates to a game system having a plurality of game machines connected with a server and a game control method for controlling them. Particularly, the present invention relates to a game system in which number of medals thrown in or credits are reserved for paying out the reserved at a big winning (“jackpot”, hereafter), and to a game control method of the game machine.

The big winning corresponding to the reserved amount of medals etc. attracts players' interest and causes continuous play of long time. It also an important factor for maintaining sales of a game machine. However, in the game machines of single player, the big winning system is not easily applied, because the reserved amount is rather small.

For example, the game machine of single player in the patent document 1 (Patent Publication Hei07-148307) is connected through communication with other game machines so that the jackpot system similar to the game machine of multi-players is provided.

In the game machine of multi-station type in the patent document 2 (Patent Publication Hei03-131288), a plurality of players play games on a common stage so as to feel a sense of unity.

### SUMMARY OF THE INVENTION

By the conventional technology, pay-out of reservation type jackpot effect can be executed through communication, however, any effect of sense of unity cannot be obtained with other players.

In the multi-station of large box, the game of each seat is substantially common to games of other seats. So, various games, for example, poker, blackjack, mahjong etc. cannot be selected freely.

When the jackpot may occur by player's operation, the jackpot change will be lost due to low skill of the player.

When the jackpot may occur regardless of player's operation, sufficient motivation of game continuation is not given to the player, because the jackpot is not notified the player previously.

The present invention is invented to solve the conventional problems and has an object to enable jackpot effect of reservation type on a game of single player. A common party game of sense of unity can be provided together with various kinds of games. The game motivation caused by the jackpot is fully applied.

The present invention is a game system having a plurality of game machines and a server connected with said game machines, wherein said game machines comprises a winning notice means, and said server comprises, a timing setting means for setting a lottery timing for jackpot, a timing judgment means for judging whether it is a lottery timing set by said timing setting means, a game machine selecting means for selecting a game machine available for said lottery when said timing judgment means judges that it is said lottery timing, a notice means of server side for notifying that there is a selected game machine when said game machine selecting means selects one of said game machines,

a lottery means for selecting by lottery a game machine which joins a game among said game machines selected by said game machine selecting means, a winning notice executing means for notifying a winning by a winning notice means for said game machine selected by said lottery means, and a game setting means for setting a game executed for deciding said jackpot on said game machine selected by said lottery means.

Therefore, game motivation caused by the jackpot is fully applied in a game system in which the jackpot occurs regardless of the player's operation.

In the game system according to the present invention, said game machine comprises, for example, a counter for recording a point automatically accumulated during said game is executed, and said timing judgment means of said server may select a game machine which accumulates said point not less than a predetermined value as said game machine which joins said game.

Therefore, the jackpot may occur according to reserved point during normal games on each game machine.

In the game system according to the present invention, said notice means of server side comprises, for example, a lamp lighting in a predetermined short time. By the uncertain lighting, the expectation on the jackpot and excitement of the player are raised.

In the game system according to the present invention, said winning notice means comprises a lamp lighting in a predetermined short time. By the uncertain lighting, the expectation on the jackpot and excitement of the player are raised.

A game control method according to the present invention for a plurality of game machines having a winning notice means comprises a timing setting step for setting a lottery timing for jackpot, a timing judgment step for judging whether it is a lottery timing set by said timing setting step, a game machine selecting step for selecting a game machine available for said lottery when said timing judgment step judges that it is said lottery timing, a first notice step for notifying that there is a selected game machine when said game machine selecting step selects one of said game machines, a lottery step for selecting by lottery a game machine which joins a game among said game machines selected by said game machine selecting step, a winning notice executing step for notifying a winning by a winning notice step for said game machine selected by said lottery step, and a game setting step for setting a game executed for deciding said jackpot on said game machine selected by said lottery step.

Therefore, game motivation caused by the jackpot is fully applied in a game system in which the jackpot occurs regardless of the player's operation.

### BRIEF DESCRIPTION OF DRAWINGS

FIG. 1 is a block diagram showing an embodiment of a game system connected to a game machine.

FIG. 2 is a block diagram showing a server in FIG. 1.

FIG. 3 is a block diagram showing a game machine (terminal machine) in FIG. 1.

FIG. 4 is a perspective view showing the server in FIG. 1.

FIG. 5 is a perspective view showing the terminal machine in FIG. 1.

FIG. 6-1 is a flowchart showing an embodiment of a game control method according to the present invention.

FIG. 6-1 is a flowchart showing a processing following to FIG. 6-1.

FIG. 7 is a flowchart showing a processing for executing a JP game.

### DETAILED DESCRIPTION OF THE PRESENT INVENTION

A preferred embodiment of the game system and game control method according to the present invention is described with reference to drawings.

### PREFERRED EMBODIMENT OF THE PRESENT INVENTION

[Game System]

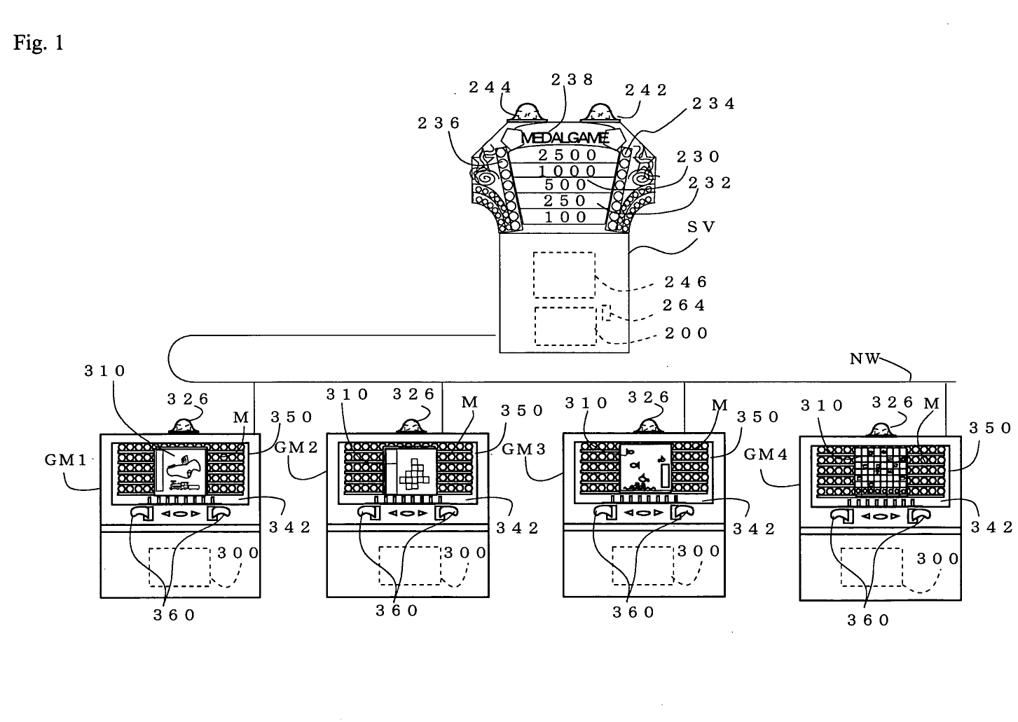

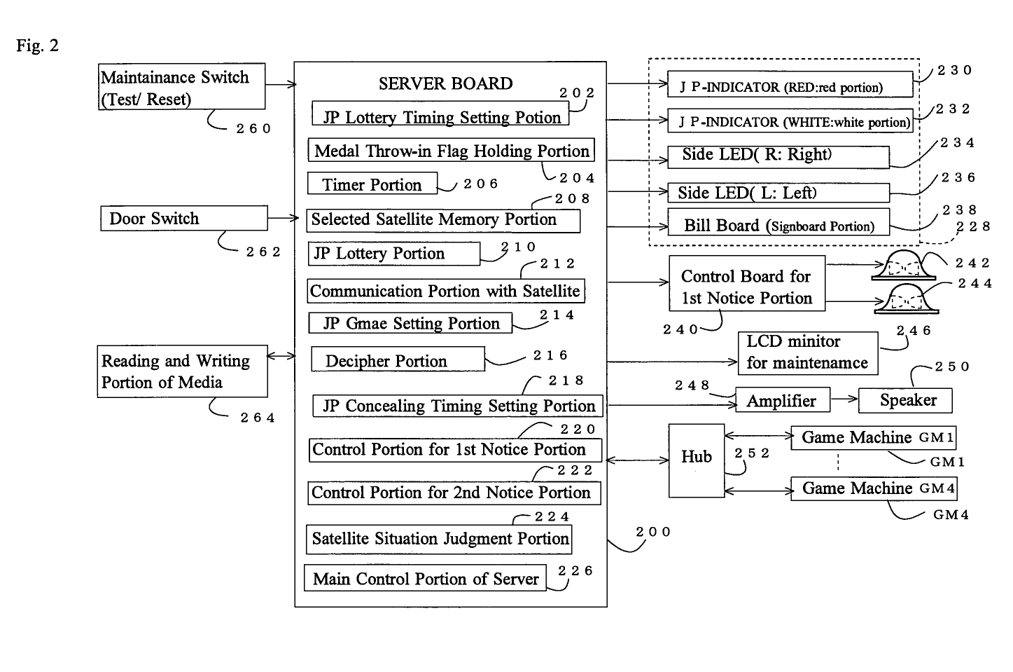

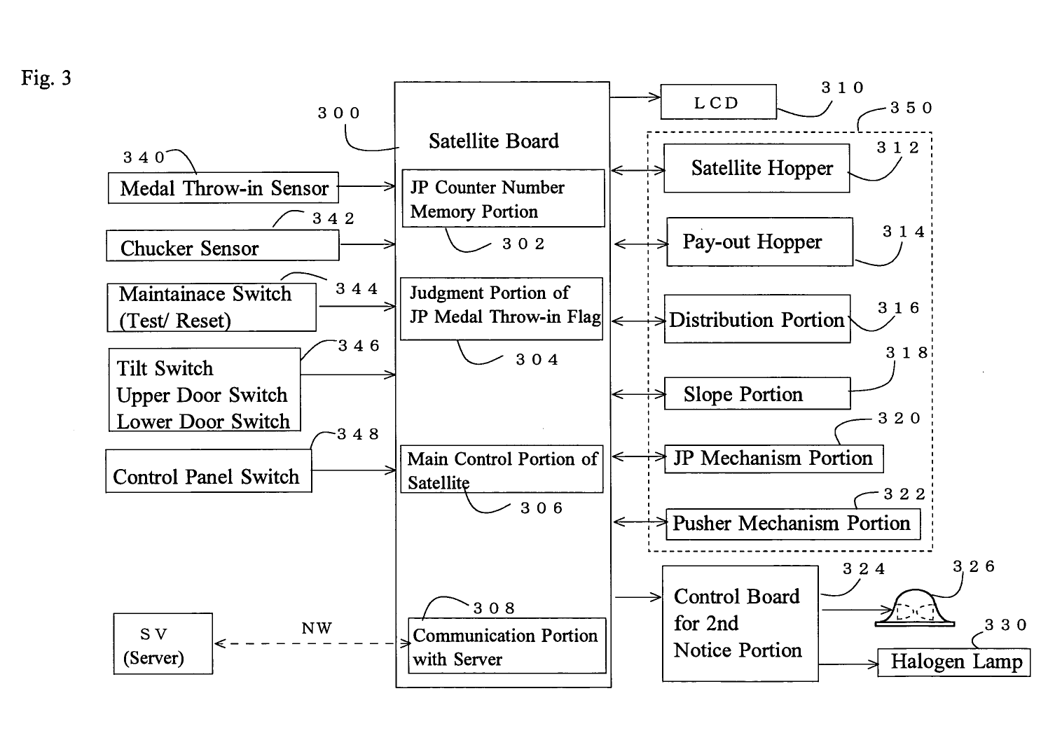

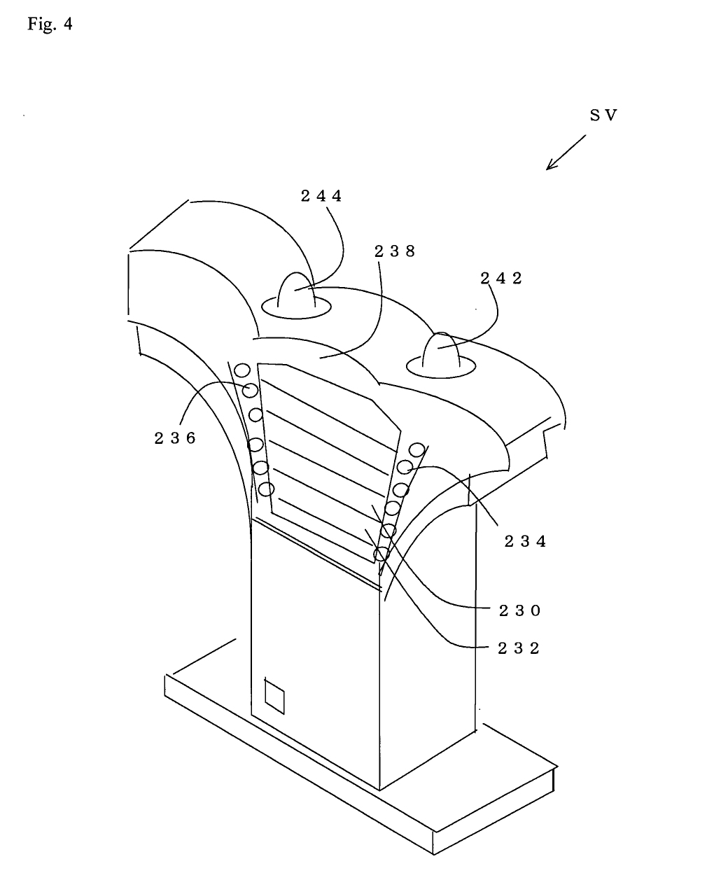

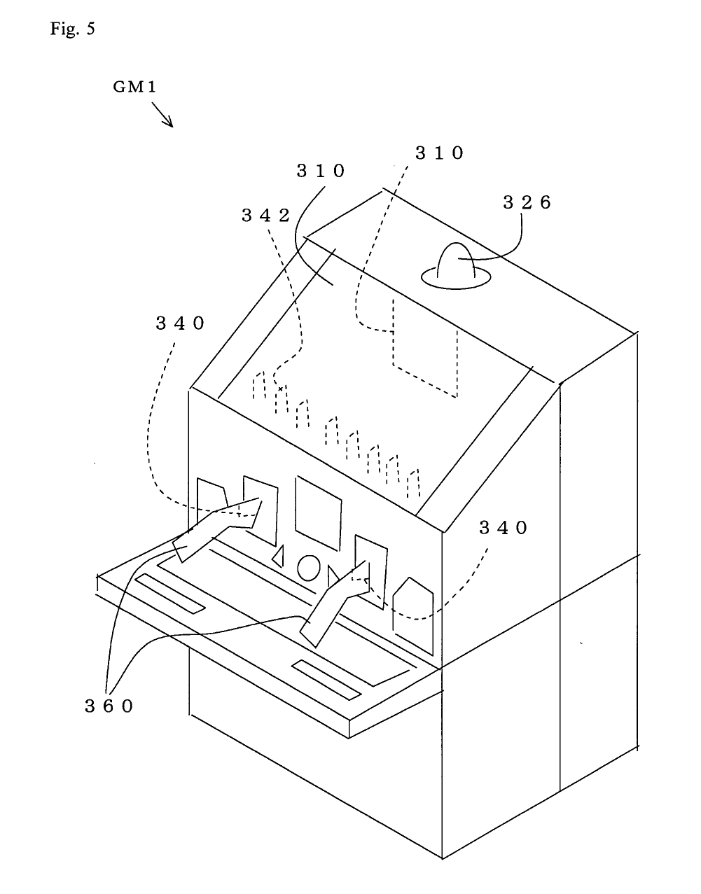

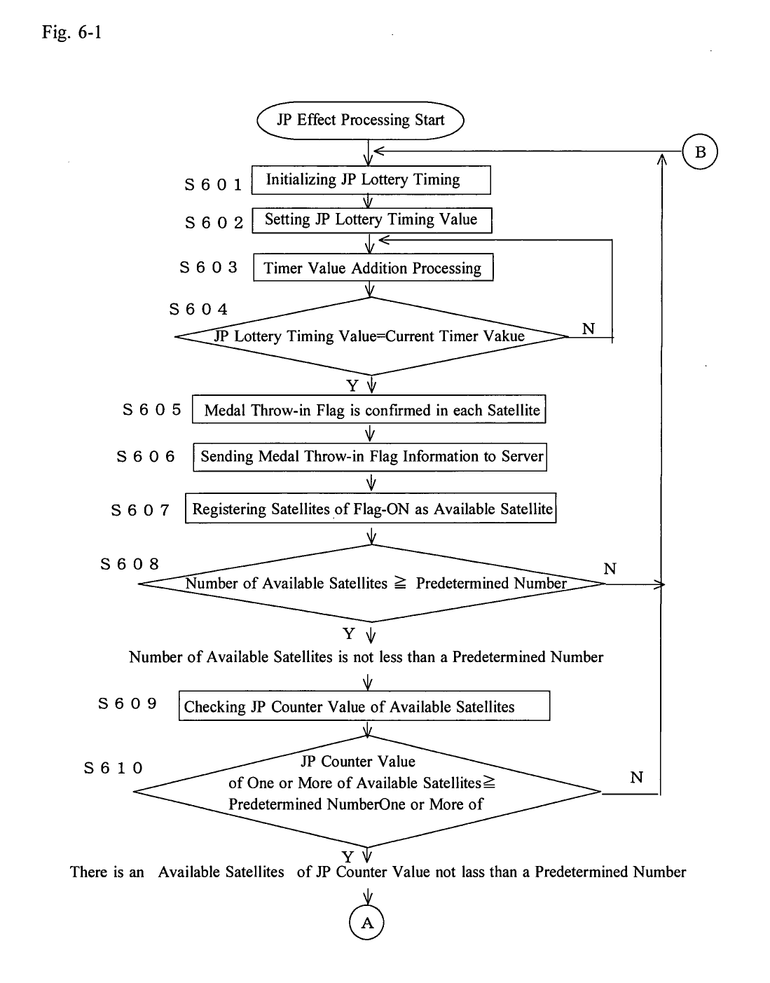

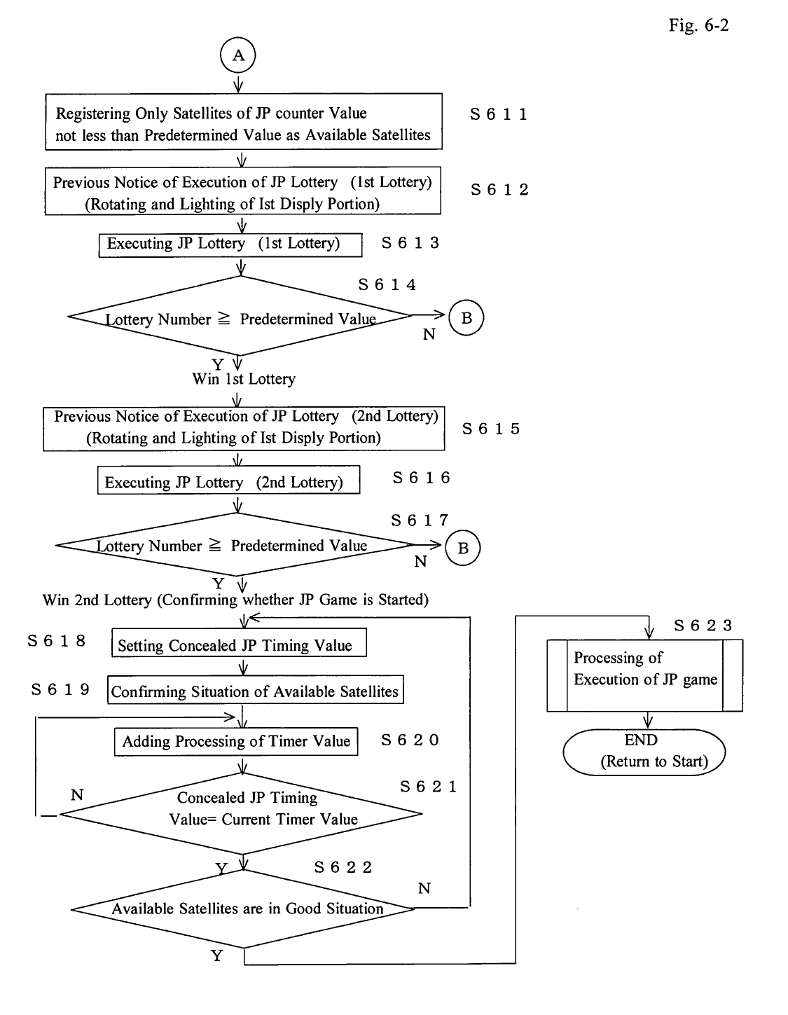

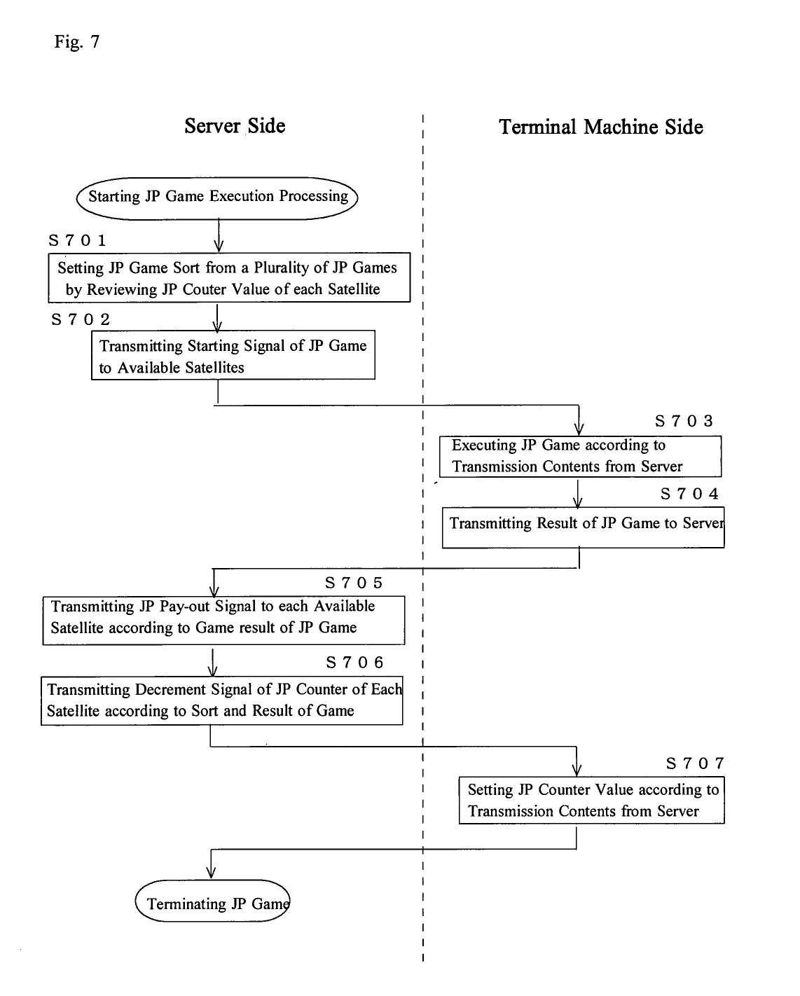

FIG. 1 is a block diagram showing an embodiment of a game system connected to a game machine. FIG. 2 is a block diagram showing a server in FIG. 1. FIG. 3 is a block diagram showing a game machine (terminal machine) in FIG. 1. FIG. 4 is a perspective view showing the server in FIG. 1. FIG. 5 is a perspective view showing the terminal machine in FIG. 1. FIG. 6-1 is a flowchart showing an embodiment of a game control method according to the present invention. FIG. 6-1 is a flowchart showing a processing following to FIG. 6-1. FIG. 7 is a flowchart showing a processing for executing a JP game.

In FIG. 1, a game control apparatus SV is connected to a plurality of different game machines GM1, GM2, GM3 and GM4 (the number is not limited to 4) though a network NW. For example, the game machines GM1 to GM4 have as a main game, a travel game by a locomotive, a block braking game, a fishing game of tropical fishes and a strategy game, respectively. Each of game machines GM1 to GM4 executes various mini games other than the main game and a jackpot party game in which a plurality of players join. A lot of medals are provided to players when they win the jackpot party game.

On a front face of the server SV, JP indicators 230 and 232, a side LED (light emission devices) 234 and 236, and a notice portion (illumination portion) such as a billboard 228 are provided. The JP indicator 230 indicates number of medals won by the terminal machine in the jackpot game (JP game).

On a top portion of the server SV, there are provided notice means of server side (1st notice portion/1st transmission means) 242 and 244 consisting of rotary lights (pat lights). The notice means of server side 242 and 244 are turned on, when there is a terminal machine for which the lottery of the jackpot is executed, so that starting of the jackpot is visually noticed.

Within the server SV, there are provided a server board 200 for executing various processing, a LCD (liquid crystal device) monitor for maintenance 246 and a media reading/writing portion 264 for reading and writing a flash memory type memory card.

On a front face of each game machine (GM1 to GM4), a pusher game unit 350 is provided. Within each game machine (GM1 to GM4), a liquid crystal device (LCD) monitor 310 is provided.

On the front face of each game machine (GM1 to GM4), handles 360 for throwing medals M with controlling the throwing direction. By throwing the medal, an input operation is executed for the game. When the medal is thrown, a medal thrown sensor 340 in the handles 360 detects situation of the medal thrown so as to transmit a signal of thrown medal to a satellite board 300 provided within the game machines.

There are provided the satellite boards 300 for various processing within the game machines (terminal machines, hereafter) GM1 to GM4. Each of the satellite boards 300 receives the a signal of thrown medal so as to transmit by a thrown flag judgment portion 304 whether there is a player at the terminal machine to a main control portion of terminal machine.

On a top portion of each of the terminal machines GM1 to GM4, there are provided winning notice means (2nd notice portions) 326 consisting of rotary lights for notifying information concerning the jackpot. The wining notice means (2nd notice portion) 326 is turned on of a game machine which can join the lottery of the jackpot, for a short time, so that the lottery situation of the jackpot is visually recognized.

In FIG. 2, JP indicators 230 and 232, side LED 234 and 236, a server illumination portion 228 such as a billboard 238, the LCD monitor 246 and a medium reading/writing portion 264 are connected to the server board 200. The notice means (1^{st} notice means) of server side 242 and 244 are connected through a control board for 1^{st} notice means 240 to the server board 200. The control board for 1^{st} notice means 240 controls rotation and time of turning on of the 1^{st} notice means 242 and 244.

A speaker 250 is connected through an amplifier 248 to the server board 200 for various effects.

A maintenance switch 260 is connected to the server board 200, which is used for resetting and maintaining the server SV.

A hub 252 is connected to the server board 200. The game machines GM1 to GM4 are connected through the network NW and the hub 252 to the server board 200.

On the server board 200, there are provided a JP lottery timing setting portion 202, a medal throw-in flag holding portion 204, a timer portion 206, a selected satellite memory portion 208, a JP lottery portion 210, a communication portion with terminal machine 212, a JP game setting portion 214, a JP concealing timing setting portion 218, a control portion for 1^{st} notice portion 220, a control portion for 2nd notice portion 222, a satellite situation judgment portion 224 and a main control portion of server 226 for executing processing (described later) concerning the jackpot.

The timer portion 206 judges a timing of concealed jackpot for an effect of jackpot after a predetermined time of concealed jackpot.

The selected satellite memory portion 208 stores the selected terminal machine.

The JP lottery portion 210 makes JP lottery for the 1^{st} and 2^{nd} jackpot lotteries.

The communication portion 212 communicates with terminal machines GM1 to GM4.

The JP game setting portion 214 sets game sorts of the jackpot games and judges the result of the jackpot games executed on the terminal machines.

The JP concealing timing setting portion 218 sets the concealing situation before the beginning of the jackpot and sets the starting timing in response to a situation of the terminal machine.

The control portion 220 controls the lighting on and off and rotation of the 1^{st} notice portion.

The control portion 222 controls the lighting on and off and rotation of the 2^{nd} notice portion.

The satellite situation judgment portion 224 receives the situation of the satellites from the communication portion 212 and transmits the situation to the JP concealing timing setting portion 218.

The main control portion 226 executes other main control than the above for a processing concerning the jackpot.

The processes above are explained by different functional blocks, however, the processes may be executed by the main control portion 226 or by other processing portions.

On the server board 200, a decipher portion 216 is further provided for deciphering an information in the medium connected to the reading and writing portion of media 264, when the information is ciphered by scrambling etc.

These components work on the server board 200 cooperatively with a CPU, a working memory and so forth. The processing may totally or partially executed by a special purpose hardware.

In FIG. 3, a LCD 310, a satellite hopper 312 as a pusher game unit 350, a pay-out hopper 314, a distribution portion 316, a slope portion 318, a JP mechanism portion 320 and a pusher mechanism portion 322 are connected to the satellite board 300. The wining notice means (2^{nd} notice portion) 326 is connected to the satellite board 300 through a control board for 2^{nd} notice portion 324. A halogen lamp 330 is connected to the control board for 2^{nd} notice portion 324 so as to be turned on and off.

A medal throw-in sensor 340, a chucker sensor 342, a maintenance switch 344 and a control panel switch 348 are connected to the satellite board 300.

The medal throw-in sensor 340 detects a medal thrown from the handle 360. The chucker sensor 342 detects whether the thrown medal passes a position (chucker) corresponding to items shown on the LCD 310. The maintenance switch 344 is used for resetting and maintaining each terminal machine. The control panel switch is a switch for inputting an input signal of other operations by players such as mini game operation than the medal throw-in operation on a control panel (not shown).

On the satellite board 300, a JP counter value memory portion 302 is provided for counting and storing the reservation situation of the thrown medals and credits, so as to record reservation point for the jackpot. In the terminal machines GM1 to GM4, points of a predetermined ratio of the medals thrown in are reserved by the JP counter value memory portion 302, the jackpot does not occur until the reserved points become a predetermined value or more.

During the jackpot processing, the server SV determines the lottery timing of the jackpot by the JP timing setting portion 202. The jackpot timing is selected, for example, from 30 to 60 minutes by a random number and determined. The lottery timing may be every predetermined time, and may increased and decreased in distance corresponding to throwing situation of the medal in each terminal machine.

The medal throw-in flag holding portion 204 holds a history of medals thrown in each of the terminal machines GM1 to GM4. Each terminal machine GM1 to GM4 receives signal from the medal throw-in sensor 340 every predetermined time (every one minute, for example), so as to transmit a signal of the judgment portion of JP medal throw-in flag 304 which stores the information of the medal throw-in sensor 340 at a predetermined timing, to the server SV. While, the medal throw-in flag holding portion 204 of the server side holds received information (whether coins are thrown or not) for a predetermined times (three times, for example).

Then, it is judged whether there is a player or not for each terminal machine GM1 to GM4. When a medal is stuffed in a throw-in inlet of the handle 360 or the medal throw-in sensor 340 is continuously on situation due to some sensor trouble, the judgment portion 304 may judges the medal throw-in flag as “off”. Therefore, it is mire precisely judged whether there is a player at each terminal machine.

The timer portion 206 of the server SV judges whether it is the timing set by the JP lottery timing setting portion 202 or not of lottery for starting the jackpot game.

The selected satellite memory portion 208 judges whether each terminal machine is used or not by the medal throw-in flag holding portion 204 and stores the situation, when the timer portion 206 judges that it is the timing for starting the jackpot lottery. When number of the used terminal machines does not reach a predetermined number, the processing of the jackpot effect is stopped.

When the number of used terminal machines is the predetermined number or more, the server SV advances to the following processing of the JP effect. The server requests each satellite board 300 to transmit the reserved point of medals or credits stored in the JP counter value memory portion 302 so as to refer the situation. If there is a terminal machine of the reserved points not less than the predetermined value, the server stores the terminal machine as a terminal machine in which the jackpot effect is processed and continues the jackpot effect processing.

At this time, the server SV lights on the 1^{st} notice portions 242 and 244 of the server side for a short time (1 second, for example). This lighting on for a short time raises expectation and excitation before the jackpot of the player. Interests of other players are attracted around the game machine but not playing at the game machine.

The JP lottery portion 210 for executing the jackpot lottery executes the lottery (1^{st} lottery) for each terminal machine stored in the selected satellite memory portion 208. The 1^{st} lottery is a lottery for generating the jackpot game (JP game). The 1^{st} lottery is executed by judging whether a random number generated by the JP lottery portion 210 is more than a predetermined value or not.

When the 1^{st} lottery is won, the jackpot effect is continued. In this case, the control portion for 2^{nd} notice portion 222 for controlling from the server of the effect of the terminal machine controls the terminal machines stored in the selected satellite memory portion 208 so that the notice means (2^{nd} notice portion) 326 is rotated and lighted on for a short time (1 second, for example) for a notice of winning of the 1^{st} lottery and for a previous notice of the 2^{nd} lottery.

By the short time lighting, the 4xpectation and excitation before the jackpot of the player is raised.

In the above embodiment, only the terminal machines are selected for jackpot lottery which satisfies the condition that the reserved jackpot point is not less than the predetermined value as well as the condition that the players have thrown the medals for more than a predetermined time. However, the terminal machines satisfying only one of the conditions may be selected to be stored in the selected satellite memory portion 208.

After the previous notice of the 2^{nd} lottery execution, the server executes the 2^{nd} lottery. When the 2^{nd} lottery is won, a party game (JP game) in which all the players join as a jackpot chance is determined to be took place. Then, the following process is processed.

First, the server sets a timing to start the jackpot game by the JP concealing timing setting portion 218. It is preferable that the time during the concealed timing before staring the game is not so long, for example 5 minutes, because the players will leave their seats in disappointment when the waiting time is much longer than the regular game period.

When the JP concealed timing is set, the server investigates how the main game is executed in the terminal machine, and the satellite situation judgment portion 224 judges whether the party game (JP game) can be started immediately or not.

If a party game is took place during an individual lottery for pay-out in a main game in one terminal machine, the player at the terminal machine loses the pay-out promised. So, the server sets the value of the JP concealed timing again so that the starting of the JP game is postponed, when the main game in each terminal machine is prevented by the party game.

After the JP game is postponed, the server comes to execution of the JP game. First, the server reviews the JP counter number stored in the JP counter value memory portion 302 in each terminal machine so as to select and set a JP game among a plurality of JP games according to the situation of the JP counter value.

For example, when the JP counter value of the total terminal machines are higher than a predetermined value, a JP game of high expectation of a lot of medals may be selected. When only a few terminal machines have high JP counter value, a game advantageous to the terminal machines may be selected and set.

The JP game setting portion 214 selects and sets a bonus game for the jackpot and lets the terminal machines stored in the selected satellite memory portion 208 execute the bonus game (JP game). Since the bonus game is selected according to the playing situation of the terminal machines connected the game system, all the players join simultaneously in the bonus game.

In other terminal machines than the selected terminal machines, the main game is executed regularly by the main control portions of the terminal machine. A special effect may be provided on the LCD display portion of the terminal machines during advertisement, to which the medals are not thrown in for several minutes. When the number of players joining in the party game is a predetermined number or less, the control portion on the server board may join the game as a virtual player for more enjoyable game.

The server SV judges the result of the bonus game when executed, and controls the terminal machines in which the players obtain the medals so that the medals or credits are paid off. The JP counter value is decreased in each terminal machine according to the bonus game result and the total pay-out situation. Then, the successive occurrence of the jackpot is of low possibility, and each player has equivalent jackpot chance in a continuous play. So, on the management side, a long time continuous play of players can be expected.

As mentioned above, the expectation and excitation of players are raised before the jackpot by the short time lighting of the 1^{st} and 2^{nd} notice portions 242, 244 and 326 in response to the lottery situation. Then, the game motivation caused by the jackpot is fully applied for example for keeping player's interest in the game.

The notice portions 242, 244 and 326 are not limited to the rotary lamp. (1) a LED and other light emission means, (2) a sound generating means and (3) an object performing a predetermined movement (character objects such as dolls, rotating propeller, floating balloons, streamers, model vehicles) and so forth.

The 1^{st} notice portions 242 and 244 are not limited to be provided in the server. The notice portions may be any notice means of the first stage for notifying the terminal machine of jackpot to players.

[Game Control Method]

The jackpot processing is not limited to the processing by the construction above. The processing may be executed by any one of the terminal machines or by any other control apparatuses. Instead of the JP counter value memory portion 302 in each terminal machine, a total management means of the counter value may be provided in the server SV etc.

In FIGS. 6-1 and 6-2, the general purpose jackpot processing is expressed by the following game control method.

Step S601: First, the jackpot lottery timing for the jackpot lottery is initialized.

Step S602: Next, the JP lottery timing is determined for executing the jackpot lottery. This lottery may be executed by a random number or by a number of week and time information based on a game situation or on a predetermined time table.

Step S603 and S604: Then, it is judged whether it is the timing set by the JP lottery timing setting portion 202 etc. This processing is processed by the timer portion 206. When it is the jackpot lottery timing, the processing is advanced to the step S605. When it is not the jackpot lottery timing, the timer value is increased until it becomes the timing.

Step S605: When the server judges that it is the jackpot lottery timing in the step S604, each terminal machine reviews the medal throw-in flag judgment portion and transmits information to the server.

Step S606, S607: The server holds the flag status transmitted in the step S605, by the medal throw-in flag holding portion 204 and stores it in the selected satellite memory portion 208.

Step S608: The server judges whether the number of the terminal machines currently used is not less than a predetermined number or not. When the number does not reach the predetermined number, the JP effect processing is immediately terminated. When the number is not less than the predetermined number, the processing is advanced to the step S609.

Step S609: The reserved points of each terminal machine stored in the selected satellite memory portion 208 are reviewed, and the processing is advanced to the step S610.

Step S610, S611: The server judges whether there are reserved points among the JP counter values reviewed in the step S609, not less than a predetermined number or not. When there are values not less than the predetermined value, the terminal machines are selected and stored in the selected satellite memory portion 208, and the processing is advanced to the step S612. When there are only values less than the predetermined value, the JP effect processing is immediately terminated and returned to the start.

Step S612: A previous notice of a short predetermined time concerning the execution of the 1^{st} lottery is given to the players, then the processing is advanced to the step S613. By the uncertain information transmission of rather short time, the expectation on the jackpot and excitement of the player are raised.

Step S613, S614: The server executes the 1^{st} lottery by the JP lottery portion 210. When won, the processing is advanced to the step S615, when lost, the JP effect processing is immediately terminated and returned to the start.

Step S615: When the lottery executed in the step S514 is won, the server let the terminal machine stored in the step S611 notify the winning of the 1^{st} lottery as well as the previous notice of 2^{nd} lottery execution for rather short time by the 2^{nd} notice portion 326 as the 1^{st} winning notice. The short time notice not easily visually recognized is uncertain notice for the players of the selected terminal machine, with giving high expectation to the players. The expectation and excitation before the jackpot are further raised.

Step S616, S617: Following to the step S615, the server executes the 2^{nd} lottery for judging whether the jackpot is to be executed or not. When the lottery is won, the processing is advanced to the step S618, when lost, the JP effect processing is immediately terminated and returned to the start.

Step S618: Following to the step S517, when the lottery in the step S617 is won, the generation of the bonus game (JP game) is determined. The server sets the timing for generating the bonus game by the JP concealed timing setting portion 218.

Step S619: The server reviews the data concerning the main game execution in each terminal machine and judges whether the main game interruption prevents the main game execution. When the pay-out is being executed for a small winning in a terminal machine, for example, the bonus game is judged to be inadequate. Then, the processing is advanced to the step S620.

Step S620, S621, S622: When the server judges that there is no problem due to interruption of the main game in each terminal machine after reviewing the main game execution in each terminal machine, the processing is advanced to the step S623. Then, the processing is transferred to the JP execution processing.

In FIG. 7, the relationship between the server SV and one of the selected terminal machines is as follows.

Step S701: On the server side, a game sort is set from a plurality of JP games by reviewing JP counter value of each terminal machine.

Step S702: Following to the step S701, the server transmits a starting signal of JP Game to available (selected) terminal machines.

Step S703: On the selected terminal machine side, following to the step S702, the JP game is executed according to the transmission contents from the server.

Step S704: Following to the step S703, the terminal machines transmits the result of the JP game.

Step S705: On the server side, following to the step S704, the server transmits the JP pay-out signal to each available (selected) terminal machine according to the game result of JP game.

Step S706: Following to the step S705, the server transmits the decrement signal of JP counter of each terminal machine according to the sort and result of the JP game.

Step S707: Following to the step S706, the terminal machines sets (decreases) the JP counter value according to the transmission contents from the server.

The embodiment above concerns medal games, however, the present invention is naturally applicable to any game system including a plurality of game machines and has jackpot effect.

According to the present invention, game motivation caused by the jackpot is fully applied in a game system in which the jackpot occurs regardless of the player's operation.

What is claimed is:

1. A game system having a plurality of game machines and a server connected with said game machines, wherein said game machines comprises a winning notice means, and said server comprises,
a timing setting means for setting a lottery timing for jackpot,
a timing judgment means for judging whether it is a lottery timing set by said timing setting means,
a game machine selecting means for selecting a game machine available for said lottery when said timing judgment means judges that it is said lottery timing,
a notice means of server side for notifying that there is a selected game machine when said game machine selecting means selects one of said game machines,
a lottery means for selecting by lottery a game machine which joins a game among said game machines selected by said game machine selecting means,
a winning notice executing means for notifying a winning by a winning notice means for said game machine selected by said lottery means, and
a game setting means for setting a game executed for deciding said jackpot on said game machine selected by said lottery means.

2. A game system according to claim 1, wherein said game machine comprises a counter for recording a point automatically accumulated during said game is executed, and said timing judgment means of said server selects a game machine which accumulates said point not less than a predetermined value as said game machine which joins said game.

3. A game system according to claim 1, wherein said notice means of server side comprises a lamp lighting in a predetermined short time.

4. A game system according to claim 1, wherein said winning notice means comprises a lamp lighting in a predetermined short time.

5. A game control method for a plurality of game machines having a winning notice means, comprising,
a timing setting step for setting a lottery timing for jackpot,
a timing judgment step for judging whether it is a lottery timing set by said timing setting step,
a game machine selecting step for selecting a game machine available for said lottery when said timing judgment step judges that it is said lottery timing,
a first notice step for notifying that there is a selected game machine when said game machine selecting step selects one of said game machines,
a lottery step for selecting by lottery a game machine which joins a game among said game machines selected by said game machine selecting step,
a winning notice executing step for notifying a winning by a winning notice step for said game machine selected by said lottery step, and
a game setting step for setting a game executed for deciding said jackpot on said game machine selected by said lottery step.
